(19) United States
(12) Patent Application Publication
(10) Pub. No.: US 2026/0061946 A1
(43) Pub. Date: Mar. 5, 2026

(54) Dual-Function Jack Brackets in Vehicles

(71) Applicant: Nissan North America, Inc., Franklin, TN (US)

(72) Inventors: Kayla Schmidt, West Bloomfield, MI (US); Praveen Mangalaglri, Soulthfield, MI (US)

(21) Appl. No.: 18/818,067

(22) Filed: Aug. 28, 2024

(51) Int. Cl. B60R 11/06; B62D 25/08; B62D 25/20

(52) U.S. Cl. CPC B60R 11/06; B62D 25/20; B62D 25/087

(57) ABSTRACT

A vehicle including: a chassis; an electronics module that is connected to the chassis; a jack mount that is connected to the chassis and which is configured to support a jack; and a dual-function jack bracket that is connected to the jack mount and the chassis such that the jack is exclusively supported by the chassis, the jack mount, and the jack bracket. The jack bracket is positioned between the electronics module and the jack mount in order to inhibit contact with the electronics module during retrieval and placement of the jack.

### TECHNICAL FIELD

The present application relates to a dual-function jack bracket in a vehicle that not only supports a jack but inhibits contact with various components in the vehicle during retrieval and placement of the jack.

### BACKGROUND

The jack is typically stored in the cargo area of a vehicle, rearwardly of the passenger seating area. For example, in many trucks, SUVs, and the like, the jack is often mounted to (or otherwise supported by) the third-row seat.

The dual-function jack bracket described herein, however, supports the jack in a vehicle that is devoid of a third-row seat, and includes a guard in order to restrict access to certain areas of the vehicle during retrieval and placement of the jack in order to inhibit contact with various components.

### SUMMARY

In one aspect of the present disclosure, a vehicle is disclosed that includes a chassis, which defines a passenger seating area and a cargo area that is located rearwardly of the passenger seating area; an electronics module that is connected to the chassis within the cargo area; a jack mount that is connected to the chassis within the cargo area and which is configured to support a jack; and a jack bracket that is connected to the jack mount and the chassis within the cargo area such that the jack is exclusively supported by the chassis, the jack mount, and the jack bracket.

The jack bracket includes: a body with a pair of legs and a bridge that extends between the pair of legs; a guard that extends laterally from the body along a width of the vehicle, wherein the guard is generally aligned with the electronics module to inhibit contact therewith during retrieval and placement of the jack; upper flanges that extend from the pair of legs in a generally vertical orientation; and lower flanges that extend rearwardly from the pair of legs and the guard such that the lower flanges are oriented in generally orthogonal relation to the upper flanges.

In certain embodiments, the jack bracket may be positioned between the electronics module and the jack mount along a length of the vehicle.

In certain embodiments, the guard may include a generally J-shaped configuration.

In certain embodiments, the upper flanges may receive upper fasteners that connect the jack bracket to the jack mount.

In certain embodiments, the lower flanges may receive lower fasteners that connect the jack bracket to the chassis.

In certain embodiments, the lower flanges may include first and second lower flanges that extend rearwardly from the legs, and a third lower flange that extends rearwardly from the guard.

In another aspect of the present disclosure, a vehicle is disclosed that includes: a chassis; an electronics module that is connected to the chassis; a jack mount that is connected to the chassis and which is configured to support a jack; and a jack bracket that is connected to the jack mount and the chassis such that the jack bracket is positioned between the electronics module and the jack mount to thereby inhibit contact with the electronics module during retrieval and placement of the jack.

In certain embodiments, the jack bracket may include a body and a guard that extends laterally from the body along a width of the vehicle, wherein the guard is generally aligned with the electronics module.

In certain embodiments, the guard may include a generally J-shaped configuration.

In certain embodiments, the body may include a pair of legs and a bridge that extends between the pair of legs.

In certain embodiments, the body may be configured such that the pair of legs and the bridge subtend first and second angles therebetween.

In certain embodiments, the body may be configured such that the first and second angles are generally identical.

In certain embodiments, the body may be configured such that the first and second angles are greater than or equal to 90 degrees.

In certain embodiments, the jack bracket may further include upper flanges that extend from the pair of legs in a generally vertical orientation, and lower flanges that extend rearwardly from the pair of legs and the guard such that the lower flanges are oriented in generally orthogonal relation to the upper flanges.

In certain embodiments, the lower flanges may include first and second lower flanges that extend rearwardly from the legs, and a third lower flange that extends rearwardly from the guard.

In certain embodiments, the upper flanges may receive upper fasteners that connect the jack bracket to the jack mount, and the lower flanges may receive lower fasteners that connect the jack bracket to the chassis.

In another aspect of the present disclosure, a vehicle is disclosed that includes: a chassis; a jack mount that is connected to the chassis and which is configured to support a jack; and a jack bracket that is connected to the jack mount and the chassis such that the jack is exclusively supported by the chassis, the jack mount, and the jack bracket.

In certain embodiments, the chassis may include a floor panel and a cross-member that is connected to the floor panel such that the cross-member extends laterally along a width of the vehicle.

In certain embodiments, the jack mount may be indirectly connected to the cross-member.

In certain embodiments, the jack bracket may be connected to the jack mount via upper fasteners and to the chassis via lower fasteners.

In certain embodiments, the jack bracket may be configured such that the upper fasteners and the lower fasteners are oriented in generally orthogonal relation.

In certain embodiments, the jack bracket may include: a body having a pair of legs and a bridge that extends between the pair of legs; a guard that extends laterally from the body along a width of the vehicle; upper flanges that receive the upper fasteners and which extend from the pair of legs in a generally vertical orientation; and lower flanges that receive the lower fasteners and which extend rearwardly from the pair of legs and the guard such that the lower flanges are oriented in generally orthogonal relation to the upper flanges.

### BRIEF DESCRIPTION OF THE DRAWINGS

According to common practice, the various features of the drawings may not be to-scale, and the dimensions of the various features may be arbitrarily expanded or reduced. Additionally, in the interest of clarity, certain components, elements, and/or features may be omitted from certain drawings in the interest of clarity.

FIG. 1 is a partial, top, front, perspective view of a vehicle that includes a dual-function jack bracket according to the principles of the present disclosure.

FIG. 2 is a top, front, perspective view illustrating connection of the jack bracket to a jack mount, and positioning of the jack bracket and the jack mount rearwardly of an electronics module.

FIG. 3 is a top, rear, perspective view illustrating access to the jack bracket and the jack mount through a storage box in the vehicle.

FIG. 4 is a top, rear, perspective view illustrating connection of the jack bracket and the jack mount to a chassis of the vehicle.

FIG. 5 is a top, rear, perspective view illustrating connection of the jack bracket to the jack mount.

FIG. 6 is a partial, bottom, rear, perspective view illustrating connection of the jack mount to the chassis.

FIG. 7 is a side, perspective view of the jack bracket.

FIG. 8 is a rear, perspective view of the jack bracket.

### DETAILED DESCRIPTION

The present disclosure describes a vehicle that includes a jack mount, which supports a jack and is connected (secured) to the chassis of the vehicle, and a dual-function jack bracket, which is connected (secured) to the jack mount and the chassis such that the jack is exclusively supported by the chassis, the jack mount, and the jack bracket (i.e., in contrast to vehicles in which the jack mount and the jack are supported by a third-row seat). In addition to supporting the jack, the jack bracket restricts access to certain areas of the vehicle during retrieval and placement of the jack in order to inhibit contact with various components.

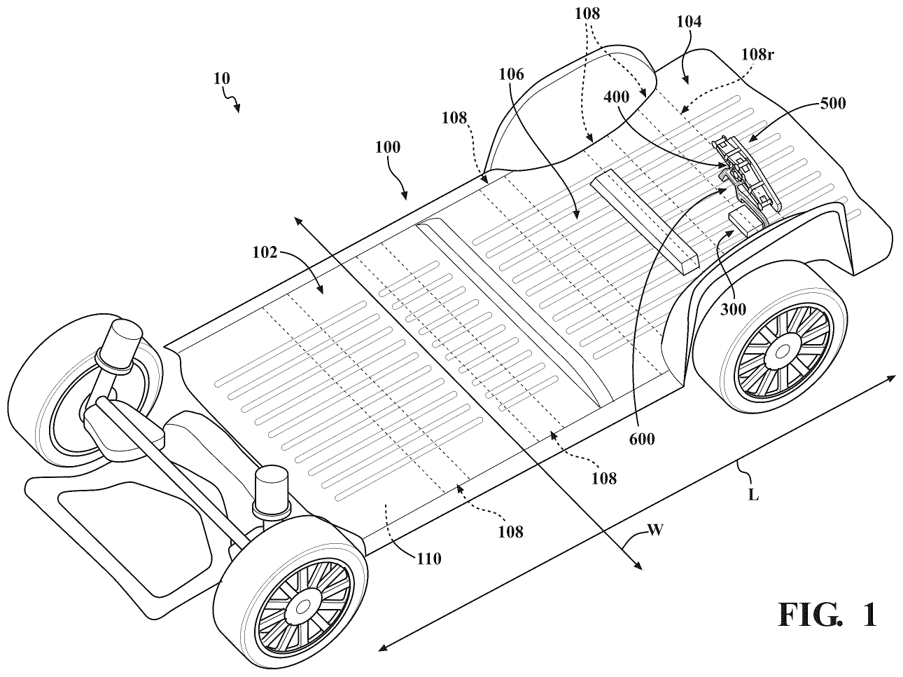

With reference to FIGS. 1-3, a vehicle 10 is disclosed that includes: a chassis 100; a storage (luggage) box 200; an electronics module 300; a jack mount 400, which supports a jack 500; and a jack bracket 600. Although generally illustrated and described in the context of a passenger vehicle, it should be appreciated that the principles of the present disclosure may be applied to a wide variety of vehicles (e.g., trucks, SUVs, vans, buses, boats, airplanes, trains, etc.).

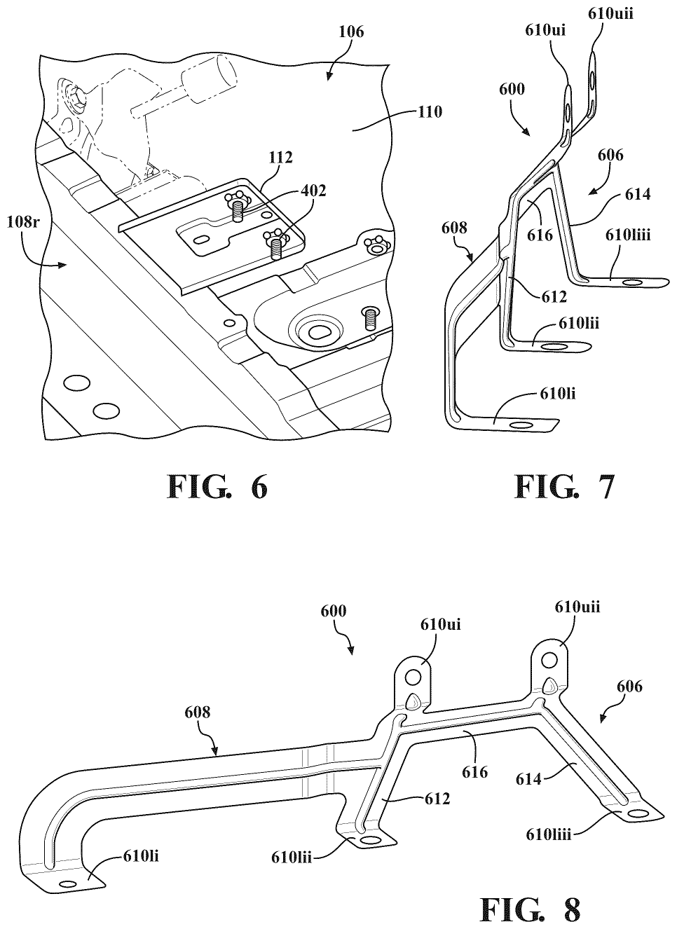

The chassis 100 defines a passenger seating area 102 (FIG. 1), which accommodates a plurality of seats (not shown) (e.g., first (front) row seats and second (rear) row seats), and a cargo area 104, which is positioned (located) rearwardly of the passenger seating area 102 along a length L of the vehicle 10. The chassis 100 includes a floor panel 106 and a plurality of cross-members (braces) 108, which are connected (secured) to an underside (bottom surface) 110 (FIGS. 1, 6) of the floor panel 106 and extend laterally across a width W of the vehicle 10 (i.e., in generally orthogonal (perpendicular) relation to the length L of the vehicle 10) to increase the strength (e.g., the rigidity) of the floor panel 106.

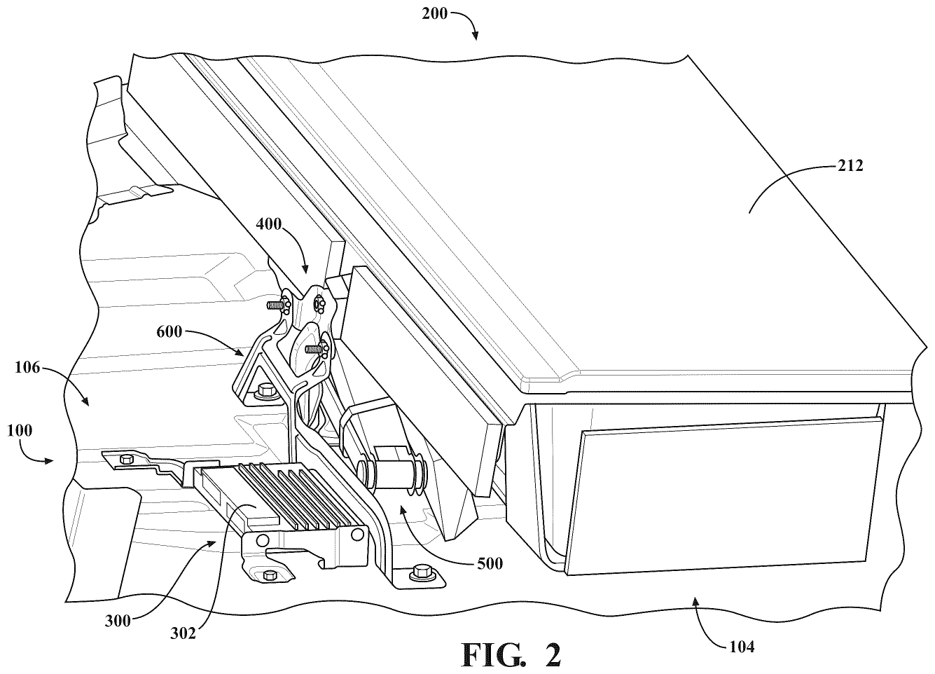

As seen in FIG. 2, the storage box 200 is positioned (located) within the cargo area 104 and is connected (secured) to the chassis 100 (i.e., the floor panel 106). More specifically, the storage box 200 is positioned rearwardly of the electronics module 300, the jack mount 400, and the jack bracket 600 such that the storage box 200 obscures the electronics module 300, the jack mount 400, and the jack bracket 600 from view when accessing the cargo area 104.

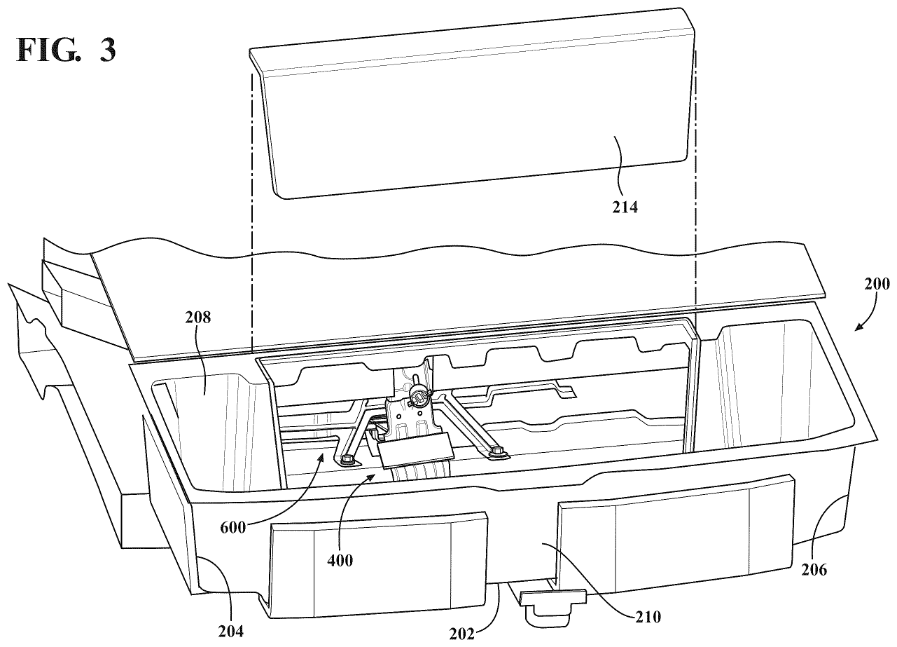

With reference now to FIG. 3 as well, the storage box 200 includes: a base wall 202, which is connected (secured) to the chassis 100 (i.e., the floor panel 106) via one or more (mechanical) fasteners (e.g., screws, bolts, pins, clips, etc.); side walls 204, 206, which extend (vertically) from the base wall 202; respective front and rear end walls 208, 210, which extend (vertically) from the base wall 202 and connect the side walls 204, 206; and a lid 212. The front end wall 208 includes a removable panel 214, which is generally aligned with the jack mount 400 and the jack bracket 600. The removable panel 214 is (repeatedly) connectable to and disconnectable from the front end wall 208, which provides access to the jack 500 (FIGS. 1, 2) through the storage box 200.

The electronics module 300 is positioned (located) within the cargo area 104 and is connected (secured) to the chassis 100 (i.e., the floor panel 106). In the particular embodiment illustrated, the electronics module 300 is configured as an advanced driver assistance system (ADAS) controller 302. It should be appreciated, however, that the electronics module 300 may include a variety of components, such as, for example, a secondary battery in the vehicle, an amplifier, etc.

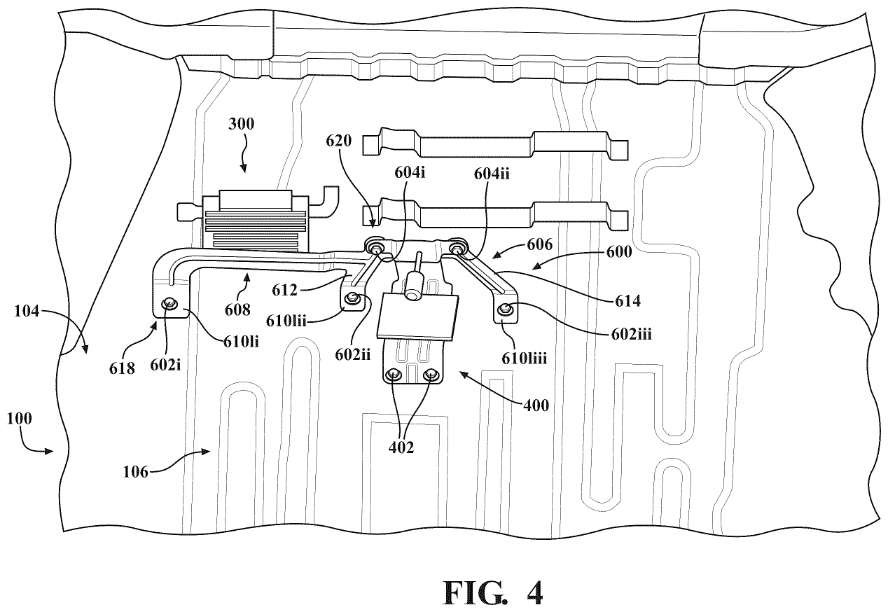

With reference now to FIGS. 4-8 as well, the jack mount 400 and the jack bracket 600 will be discussed.

The jack mount 400 is connected (secured) to the chassis 100 within the cargo area 104 and is positioned (located) forwardly of the storage box 200 such that the jack mount 400 and, thus, the jack 500, are generally aligned with the removable panel 214 (i.e., along the width W of the vehicle 10), as seen in FIG. 3. More specifically, the jack mount 400 is directly connected to the floor panel 106 and indirectly connected to a rearmost cross-member 108r (FIGS. 1, 6), which is connected (secured) (e.g., welded) to rear shock towers of the vehicle 10 and is generally aligned with a rear axle thereof (i.e., along the length L of the vehicle 10). The jack mount 400 is directly connected to the floor panel 106 via (mechanical) fasteners 402 (e.g., screws, bolts, pins, clips, etc.) (FIGS. 4-6), which extend through the floor panel 106 and into a support plate 112 (FIG. 6) that is connected (secured) (e.g., welded) to the rearmost cross-member 108r.

The jack bracket 600 is positioned within the cargo area 104 between the electronics module 300 and the jack mount 400 (i.e., along the length L of the vehicle 10), which restricts access to the cargo area 104 in order to inhibit contact with the electronics module 300 during retrieval and placement of the jack 500, as described in further detail below.

The jack bracket 600 supports the jack mount 400 and is connected (secured) to both the jack mount 400 and the chassis 100 such that the jack 500 is exclusively supported by the chassis 100, the jack mount 400, and the jack bracket 600. More specifically, the jack bracket 600 is directly connected to the floor panel 106 and the rearmost cross-member 108r via lower (mechanical) fasteners 602 (e.g., screws, bolts, pins, clips, etc.), which extend through the floor panel 106 and into the rearmost cross-member 108r (FIGS. 1, 6), and is directly connected to the jack mount 400 via upper (mechanical) fasteners 604 (e.g., screws, bolts, pins, clips, etc.), which extend through the jack mount 400 and into the jack bracket 600. The jack mount 400 is, thus, indirectly connected to the rearmost cross-member 108r by not only the support plate 112 (FIG. 6), but by the jack bracket 600 as well.

The jack bracket 600 includes a body 606; a guard 608; and a plurality of flanges 610. In the illustrated embodiment, the jack bracket 600 is unitary (monolithic, integral) in construction such that the body 606 and the guard 608 are formed from a single piece of metallic material. Embodiments in which the body 606 and the guard 608 may be formed as separate, discrete components that are connected (secured) together (e.g., via one or more (mechanical) fasteners, via welding, etc.) are also envisioned herein, however, as are embodiments in which the jack bracket 600 may include non-metallic material(s) and would not be beyond the scope of the present disclosure.

The body 606 includes a pair of (first and second) legs 612, 614 and a bridge 616 that extends between the legs 612, 614 along (i.e., in generally parallel relation to) the width W (FIG. 1) of the vehicle 10.

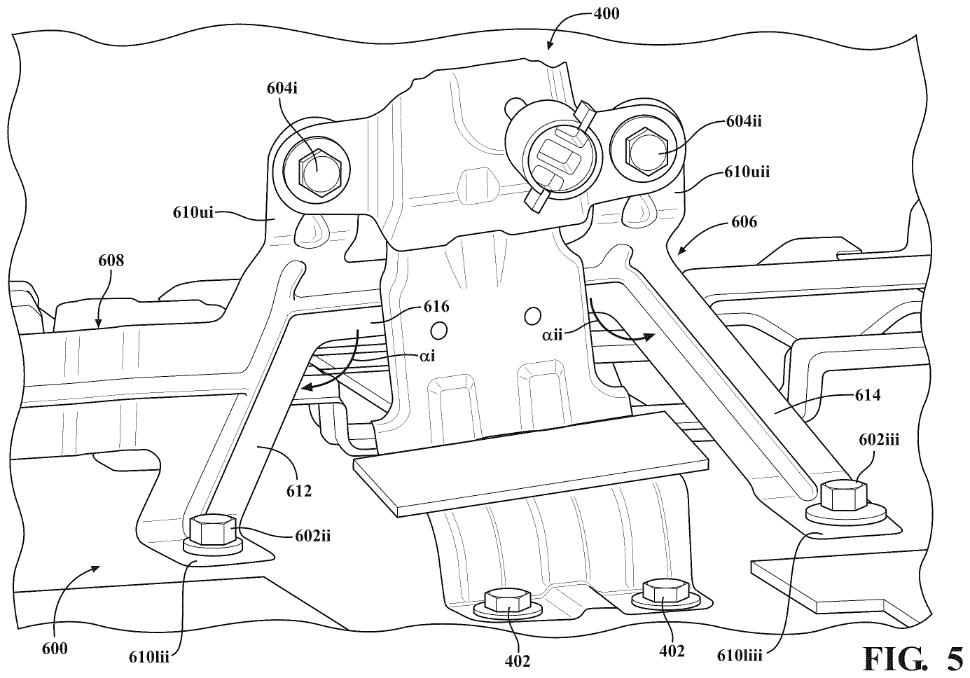

As seen in FIG. 5, the body 606 is configured such that the legs 612, 614 and the bridge 616 subtend (first and second) angles αi, αii therebetween. More specifically, in the illustrated embodiment, the body 606 is configured such that the angles αi, αii are greater than or equal to 90 degrees (e.g., to increase the stability of the jack bracket 600 and, thus, the jack mount 400) and generally identical. Embodiments in which the body 606 may be configured such that the angle αi and/or the angle αii may be less than 90 degrees are also envisioned herein, however, as are embodiments in which the angles αi, αii may be non-identical and would not be beyond the scope of the present disclosure.

The guard 608 extends laterally from the body 606 along (i.e., in generally parallel relation to) the width W of the vehicle 10 and includes a generally J-shaped configuration. More specifically, the guard 608 is generally aligned with the electronics module 300 (i.e., along the width W of the vehicle 10), as seen in FIG. 4, so as to inhibit contact therewith during retrieval and placement of the jack 500.

The flanges 610 extend from the body 606 and the guard 608 and receive the respective lower and upper fasteners 602, 604. More specifically, the jack bracket 600 includes lower flanges 610l, which receive the lower fasteners 602 in order to connect the jack bracket 600 to the chassis 100 at a lower attachment site 618 (FIG. 4), and upper flanges 610u, which receive the upper fasteners 604 in order to connect the jack bracket 600 to the jack mount 400 at an upper attachment site 620.

In the illustrated embodiment, the jack bracket 600 includes (first, second, and third) lower flanges 610li, 610lii, 610liii (FIG. 4), which receive (first, second, and third) lower fasteners 602i, 602ii, 602iii, respectively, and (first and second) upper flanges 610ui, 610uii (FIG. 5), which receive (first and second) upper fasteners 604i, 604ii, respectively. Whereas the upper flanges 610ui, 610uii extend from the legs 612, 614 in a generally vertical orientation, respectively, the lower flanges 610li, 610lii extend rearwardly from the legs 612, 614, respectively, and the lower flange 610liii extends rearwardly from the guard 608 such that the lower flanges 610li, 610lii, 610liii are oriented in generally orthogonal (perpendicular) relation to the upper flanges 610ui, 610uii, and the fasteners 602i, 602ii, 602iii are oriented in generally orthogonal (perpendicular) relation to the fasteners 604i, 604ii.

Although shown as described as including five flanges 610 and five fasteners 602, 604 in the illustrated embodiment, it is envisioned that the particular number of flanges 610 and/or fasteners 602, 604 may be varied in alternate embodiments without departing from the scope of the present disclosure (e.g., depending upon the particular configuration of the vehicle 10).

In certain embodiments, it is envisioned that the jack bracket 600 may include a coating (e.g., black paint) in order to improve the overall aesthetic appearance thereof, improve performance, and/or inhibit damage (e.g., scratching, corrosion, etc.).

Persons skilled in the art will understand that the various embodiments of the disclosure described herein and shown in the accompanying figures constitute non-limiting examples, and that additional components and features may be added to any of the embodiments discussed herein above without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (i.e., an angle that lies within the range of (approximately) 135° to (approximately) 225°) and the term “generally orthogonal” should be understood as referring to configurations in with the pertinent components are oriented so as to define an angle therebetween that is equal to 90°±25% (i.e., an angle that lies within the range of (approximately) 67.5° to (approximately) 112.5°). The term “generally parallel” should thus be understood as referring to encompass configurations in which the pertinent components are arranged in parallel relation, and the term “generally orthogonal” should thus be understood as referring to encompass configurations in which the pertinent components are arranged in orthogonal relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A vehicle comprising:
a chassis defining a passenger seating area, and a cargo area located rearwardly of the passenger seating area;
an electronics module connected to the chassis within the cargo area;
a jack mount connected to the chassis within the cargo area and configured to support a jack; and
a jack bracket connected to the jack mount and the chassis within the cargo area such that the jack is exclusively supported by the chassis, the jack mount, and the jack bracket, wherein the jack bracket includes:
a body including:
a pair of legs; and
a bridge extending between the pair of legs;
a guard extending laterally from the body along a width of the vehicle, wherein the guard is generally aligned with the electronics module to inhibit contact therewith during retrieval and placement of the jack.
upper flanges extending from the pair of legs in a generally vertical orientation; and
lower flanges extending rearwardly from the pair of legs and the guard such that the lower flanges are oriented in generally orthogonal relation to the upper flanges.

2. The vehicle of claim 1, wherein the jack bracket is positioned between the electronics module and the jack mount along a length of the vehicle.

3. The vehicle of claim 1, wherein the guard includes a generally J-shaped configuration.

4. The vehicle of claim 1, wherein the upper flanges receive upper fasteners connecting the jack bracket to the jack mount, and wherein the lower flanges receive lower fasteners connecting the jack bracket to the chassis.

5. The vehicle of claim 4, wherein the lower flanges include:
first and second lower flanges extending rearwardly from the legs; and
a third lower flange extending rearwardly from the guard.

6. A vehicle comprising:
a chassis;
an electronics module connected to the chassis;
a jack mount connected to the chassis and configured to support a jack; and
a jack bracket connected to the jack mount and the chassis such that the jack bracket is positioned between the electronics module and the jack mount to thereby inhibit contact with the electronics module during retrieval and placement of the jack.

7. The vehicle of claim 6, wherein the jack bracket includes:
a body; and
a guard extending laterally from the body along a width of the vehicle, wherein the guard is generally aligned with the electronics module.

8. The vehicle of claim 7, wherein the guard includes a generally J-shaped configuration.

9. The vehicle of claim 7, wherein the body includes:
a pair of legs; and
a bridge extending between the pair of legs.

10. The vehicle of claim 9, wherein the body is configured such that the pair of legs and the bridge subtend first and second angles therebetween.

11. The vehicle of claim 10, wherein the body is configured such that the first and second angles are generally identical.

12. The vehicle of claim 10, wherein the body is configured such that the first and second angles are greater than or equal to 90 degrees.

13. The vehicle of claim 9, the jack bracket further includes:
upper flanges extending from the pair of legs in a generally vertical orientation; and
lower flanges extending rearwardly from the pair of legs and the guard such that the lower flanges are oriented in generally orthogonal relation to the upper flanges.

14. The vehicle of claim 13, wherein the lower flanges include:
first and second lower flanges extending rearwardly from the legs; and
a third lower flange extending rearwardly from the guard.

15. The vehicle of claim 14, wherein the upper flanges receive upper fasteners connecting the jack bracket to the jack mount, and wherein the lower flanges receive lower fasteners connecting the jack bracket to the chassis.

16. A vehicle comprising:
a chassis;
a jack mount connected to the chassis and configured to support a jack; and
a jack bracket connected to the jack mount and the chassis such that the jack is exclusively supported by the chassis, the jack mount, and the jack bracket.

17. The vehicle of claim 16, wherein the chassis includes:
a floor panel; and
a cross-member connected to the floor panel such that the cross-member extends laterally along a width of the vehicle, wherein the jack mount is indirectly connected to the cross-member.

18. The vehicle of claim 16, wherein the jack bracket is connected to the jack mount via upper fasteners and to the chassis via lower fasteners.

19. The vehicle of claim 18, wherein the jack bracket is configured such that the upper fasteners and the lower fasteners are oriented in generally orthogonal relation.

20. The vehicle of claim 18, wherein the jack bracket includes:
a body including:
a pair of legs; and
a bridge extending between the pair of legs;
a guard extending laterally from the body along a width of the vehicle;
upper flanges receiving the upper fasteners and extending from the pair of legs in a generally vertical orientation; and
lower flanges receiving the lower fasteners and extending rearwardly from the pair of legs and the guard such that the lower flanges are oriented in generally orthogonal relation to the upper flanges.
